(19) United States
(12) Patent Application Publication
(10) Pub. No.: US 2018/0152562 A1
(43) Pub. Date: May 31, 2018

(54) MULTI-PARTY CALL METHOD AND DEVICE FOR MULTI-CHANNEL TERMINAL

(71) Applicant: SPREADTRUM COMMUNICATIONS (SHANGHAI) CO., LTD., Shanghai (CN)

(72) Inventors: Jinjin NI, Shanghai (CN); Xichun GAO, Shanghai (CN); Xianliang CHEN, Shanghai (CN); Yi HE, Shanghai (CN); Yiguo ZHAO, Shanghai (CN)

(21) Appl. No.: 15/800,667

(22) Filed: Nov. 1, 2017

(30) Foreign Application Priority Data
Nov. 29, 2016 (CN) 201611073262.6

(51) Int. Cl. H04M 3/56; H04M 1/725; H04W 72/04; H04M 7/00

(52) U.S. Cl. CPC H04M 3/562; H04M 1/7253; H04W 72/0413; H04M 7/0015; H04W 72/042

(57) ABSTRACT

Multi-party call method and device for a multi-channel terminal are provided. The method includes: receiving downlink service data corresponding to at least two remote subscribers through at least two service channels, respectively; and for each of the at least two remote subscribers, a local terminal mixing downlink service data corresponding to other remote subscriber among the at least two remote subscribers which excludes the remote subscriber into uplink service data transmitted by a current subscriber, and transmitting to the remote subscriber the mixed uplink service data of the current subscriber through a service channel corresponding to the remote subscriber, wherein the at least two service channels are set up based on different wireless networks. The method and device may improve flexibility of setting up a multi-party call.

### CROSS-REFERENCE TO RELATED APPLICATIONS

The present invention claims priority to Chinese patent application No. 201611073262.6, filed on Nov. 29, 2016, the entire disclosure of which is incorporated herein by reference.

### TECHNICAL FIELD

The present disclosure generally relates to communication field, and more particularly, to multi-party call method and device for a multi-channel terminal.

### BACKGROUND

With the continuous improvement of mobile network bandwidth and continuous optimization of upload and download rates, currently, calls of mobile terminals mainly include a variety of traditional related service based on data, such as voice call or video call.

With the development of mobile network, there are more and more demands on multi-party call performed by multiple terminals. However, existing multi-party calls must rely on a network, thus it is not flexible to set up a multi-party call.

### SUMMARY

In embodiments of the present disclosure, a multi-party call may be set up more flexibly.

In an embodiment of the present disclosure, a multi-party call method for a multi-channel terminal is provided, including: receiving downlink service data corresponding to at least two remote subscribers through at least two service channels, respectively; and for each of the at least two remote subscribers, a local terminal mixing downlink service data corresponding to other remote subscriber among the at least two remote subscribers which excludes the remote subscriber into uplink service data transmitted by a current subscriber, and transmitting to the remote subscriber the mixed uplink service data of the current subscriber through a service channel corresponding to the remote subscriber, wherein the at least two service channels are set up based on different wireless networks.

Optionally, the uplink service data transmitted by the current subscriber may include service data generated by the current subscriber.

Optionally, the method may further include: after downlink service data corresponding to the at least two remote subscribers are mixed, outputting the mixed data.

Optionally, in a call among the current subscriber and the at least two remote subscribers, the current subscriber may be a calling party or a called party.

Optionally, the different wireless networks may be selected from WiFi network, 2G network, 3G network, 4G network and 5G network.

Optionally, service corresponding to the at least two service channels may include voice service or video service.

Optionally, service corresponding to the at least two service channels may include VoLTE service, Circuit Switched (CS) domain service or VoWiFi service.

Optionally, the at least two service channels may retain an activated state.

In an embodiment of the present disclosure, a multi-party call device for a multi-channel terminal is provided, including: an uplink service data receiving circuitry configured to receive downlink service data corresponding to at least two remote subscribers through at least two service channels, respectively; and a service data mixing circuitry configured to: for each of the at least two remote subscribers, mixing downlink service data corresponding to other remote subscriber among the at least two remote subscribers which excludes the remote subscriber into uplink service data transmitted by a current subscriber, and transmit to the remote subscriber the mixed uplink service data of the current subscriber through a service channel corresponding to the remote subscriber, wherein the at least two service channels are set up based on different wireless networks.

Optionally, the uplink service data transmitted by the current subscriber may include service data generated by the current subscriber.

Optionally, the device may further include a remote subscriber data mixing circuitry configured to: after downlink service data corresponding to the at least two remote subscribers are mixed, output the mixed data.

Optionally, in a call among the current subscriber and the at least two remote subscribers, the current subscriber may be a calling party or a called party.

Optionally, the different wireless networks may be selected from WiFi network, 2G network, 3G network, 4G network and 5G network.

Optionally, service corresponding to the at least two service channels may include voice service or video service.

Optionally, service corresponding to the at least two service channels may include VoLTE service, CS domain service or VoWiFi service.

Optionally, the at least two service channels may retain an activated state.

Embodiments of the present disclosure may provide following advantages. Downlink service data corresponding to the at least two remote subscribers is received through the at least two service channels, respectively. For each of the at least two remote subscribers, the local terminal mixes downlink service data corresponding to other remote subscriber among the at least two remote subscribers which excludes the remote subscriber into uplink service data transmitted by the current subscriber, and transmits to the remote subscriber the mixed uplink service data of the current subscriber through the service channel corresponding to the remote subscriber. Besides, the local terminal can receive downlink data transmitted by the at least two remote subscribers. Therefore, both the current subscriber and the at least two remote subscribers can receive data from any other subscribers, so as to complete the multi-party call.

Further, to each remote subscriber, downlink service data corresponding to other subscriber is transmitted. Therefore, in embodiments of the present disclosure, the multi-party call method may not rely on a network, and thus be more flexible. Besides, as the at least two service channels are set up based on different wireless networks, the multi-party call may be set up among different wireless networks, which enables wider application scenes.

### BRIEF DESCRIPTION OF THE DRAWINGS

FIG. 1 schematically illustrates a flow chart of a multi-party call method for a multi-channel terminal according to an embodiment;

FIG. 2 schematically illustrates an application scene diagram of a multi-party call method for a multi-channel terminal according to an embodiment; and

FIG. 3 schematically illustrates a structural diagram of a multi-party call device for a multi-channel terminal according to an embodiment.

### DETAILED DESCRIPTION

As described in the background, with the development of mobile network, there are more and more demands on multi-party call performed by multiple terminals. However, existing multi-party calls must rely on a network, thus it is not flexible to set up a multi-party call.

Inventors found that, existing multi-party call is realized by: setting up a call among multiple terminals; sending to a network a request for setting up a multi-party call; and the network setting up the multi-party call. Therefore, in the existing techniques, the multi-party call is set up by the network, which has poor flexibility.

In embodiments of the present disclosure, the current subscriber may set up at least two service channels, and further set up calls with at least two remote subscribers through different service channels, respectively. In this way, a communication basis is provided for setting up the multi-party call in a more flexible way.

For each of the at least two remote subscribers, the local terminal mixes downlink service data corresponding to other remote subscriber among the at least two remote subscribers which excludes the remote subscriber into uplink service data transmitted by the current subscriber, and transmits to the remote subscriber the mixed uplink service data of the current subscriber through the service channel corresponding to the remote subscriber, so that each remote subscriber can receive data from other subscribers. Besides, the local terminal can receive downlink data transmitted by the at least two remote subscribers. Therefore, both the current subscriber and the at least two remote subscribers can receive data from any other subscribers, so as to complete the multi-party call.

In embodiments of the present disclosure, the multi-party call method doesn't need to set up the multi-party call through a network, thus the flexibility and user experience are improved. Besides, as the at least two service channels are set up based on different wireless networks, the multi-party call may be set up among different wireless networks, which enables wider application scenes.

In order to clarify the object, solutions and advantages of embodiments of the present disclosure, embodiments of present disclosure will be described clearly in detail in conjunction with accompanying drawings.

FIG. 1 schematically illustrates a flow chart of a multi-party call method for a multi-channel terminal according to an embodiment. The method may include:

S12, receiving downlink service data corresponding to at least two remote subscribers through at least two service channels, respectively, wherein the at least two service channels are set up based on different wireless networks; and

S13, for each of the at least two remote subscribers, a local terminal mixing downlink service data corresponding to other remote subscriber among the at least two remote subscribers which excludes the remote subscriber into uplink service data transmitted by a current subscriber, and transmitting to the remote subscriber the mixed uplink service data of the current subscriber through a service channel corresponding to the remote subscriber.

In some embodiments, the method may further include:

S11, setting up calls with the at least two remote subscribers through the at least two service channels, respectively.

In some embodiments, the current subscriber may be a subscriber that initiates the multi-party call using the multi-channel terminal, and the local terminal may be the multi-channel terminal which initiates the multi-party call. The call may include voice call, video call and so on. More embodiments may be obtained by those skilled in the art according to practical requirements, and are not described in detail here. Further, call means transmitting service data in a service channel.

In some embodiments, the service channel may be a channel for transmitting service data, such as voice or video, and be used for handling voice service, video service and so on. The service channel may be set up based on an LTE network. For example, the service channel may be a VoLTE service channel, the video service or voice service may be VoLTE service, and the service data may be video service data or voice service data based on VoLTE.

In some embodiments, the service channel may be set up based on a WiFi network. For example, the service channel may be a VoWiFi service channel, the video service or voice service may be VoWiFi service, and the service data may be video service data or voice service data based on VoWiFi. Similarly, the service channel may be a channel of a CS domain based on 2G or 3G network.

The at least two service channels being setting up based on different wireless networks means that, among the at least two service channels, there are service channels which are set up based on different wireless networks. The wireless networks and the number of service channels which are set up base on a same wireless network are not limited.

In some embodiments, the multi-channel terminal may set up two service channels, one being a VoLTE service channel based on an LTE network, and the other being a VoWiFi service channel based on a WiFi network. The multi-channel terminal may set up more service channels, a portion being based on the LTE network, and the other portion being based on the WiFi network.

The service channels set up by the multi-channel terminal may include service channels based on WiFi, 2G, 3G, 4G and 5G networks, or include service channels based on 2G, 4G and 5G networks.

In some embodiments, the downlink service data corresponding to the at least two remote subscribers may be voice service data. In some embodiments, the downlink service data corresponding to the at least two remote subscribers may be video service data. In some embodiments, service data corresponding to a portion of the service channels may be voice service data, and service data corresponding to the other portion of the service channels may be video service data. The local terminal or a terminal where the remote subscriber is located may selectively output data to a subscriber according to a selection of the subscriber.

The wireless networks may include various networks, such as 5G, 4G, 3G, 2G and WiFi networks, or may be a Wireless Local Area Network (WLAN). Those skilled in the art can understand that any network using a radio electromagnetic wave as a transmission medium can be used as the wireless network in embodiments of the present disclosure.

In some embodiments, the uplink service data transmitted by the current subscriber may include service data generated by the current subscriber, such as voice service data of the current subscriber.

In some embodiments, the multi-channel terminal as the local terminal may output the mixed data after downlink service data corresponding to the at least two remote subscribers are mixed. The outputting may be implemented via a human-computer interaction device of the multi-channel terminal, such as an earphone or a display screen.

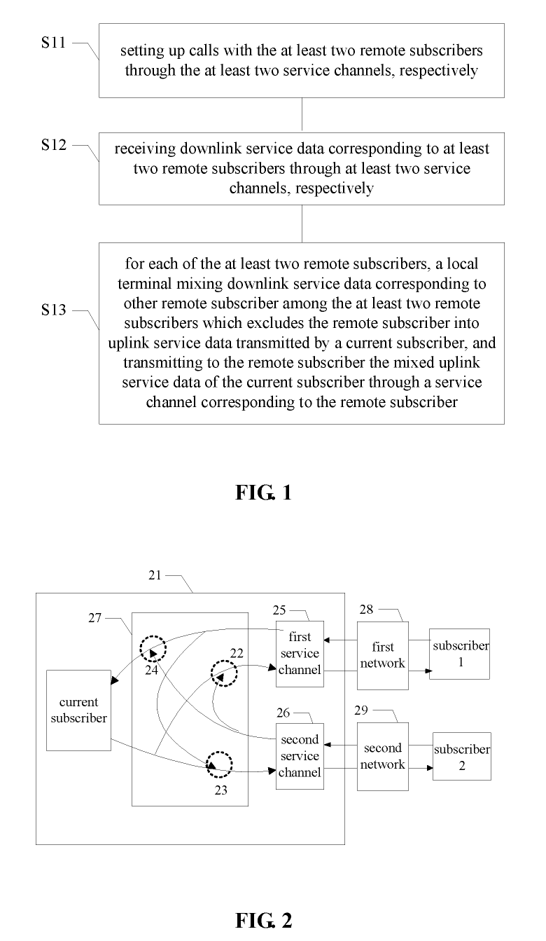

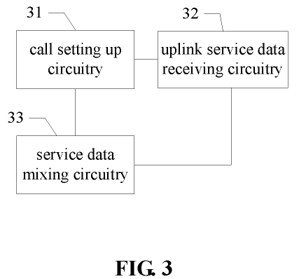

To more easily understand the solutions in FIG. 1, further description is made in conjunction with FIG. 2. FIG. 2 schematically illustrates an application scene diagram of a multi-party call method for a multi-channel terminal according to an embodiment.

Referring to FIG. 2, a terminal 21 serves as the multi-channel terminal in embodiments of the present disclosure. The current subscriber may be in calls with at least two remote subscribers (i.e., a subscriber 1 and a subscriber 2) using the terminal 21. Specifically, the current subscriber may set up a call with the subscriber 1 through a first service channel 25, and set up a call with the subscriber 2 through a second service channel 26. The first service channel 25 may be set up based on a first network 28, and the second service channel 26 may be set up based on a second network 29. The first network 28 and the second network 29 may be different networks selected from WiFi, 2G, 3G, 4G and 5G networks.

In a call among the current subscriber and the at least two remote subscribers, the current subscriber may be a calling party or a called party. For example, the current subscriber may set up a call with the subscriber 1 which serves as a calling party, and as a called party of the subscriber 2 set up another call.

The current subscriber may receive uplink service data from the subscriber 1 through the first service channel 25, and receive uplink service data from the subscriber 2 through the second service channel 26.

It should be noted that, in communication field, uplink service data generally denotes to data transmitted by a subscriber to a network, and downlink service data generally denotes to data received by the subscriber from the network. Therefore, it could be understood that, the uplink service data transmitted by the subscriber 1 or 2 is downlink service data for the current subscriber, i.e., the downlink service data corresponding to the subscriber 1 or 2 mentioned in the embodiments of the present disclosure. Uplink service data transmitted by the current subscriber is downlink service data to the subscriber 1 or 2.

With respect to the subscriber 1, other remote subscriber among the at least two subscribers which excludes the subscriber 1 is the subscriber 2. The current subscriber may receive uplink service data transmitted by the subscriber 2 via the terminal 21, and the terminal 21 may mix the uplink service data transmitted by the subscriber 2 to the uplink service data transmitted by the current subscriber, and transmit the mixed data to the subscriber 1 through the first service channel 25. In some embodiments, the terminal 21 may mix service data generated by the current subscriber to the uplink service data transmitted by the current subscriber, and transmit the mixed data to the subscriber 1 through the first service channel 25. Data flow direction of the above process may refer to a node 22.

Similarly, with respect to the subscriber 2, other remote subscriber among the at least two subscribers which excludes the subscriber 2 is the subscriber 1. The current subscriber may receive uplink service data transmitted by the subscriber 1 via the terminal 21, and the terminal 21 may mix the uplink service data transmitted by the subscriber 1 to the uplink service data transmitted by the current subscriber, and transmit the mixed data to the subscriber 2 through the second service channel 26. In some embodiments, the terminal 21 may mix service data generated by the current subscriber to the uplink service data transmitted by the current subscriber, and transmit the mixed data to the subscriber 1 through the second service channel 26. Data flow direction of the above process may refer to a node 23.

From a node 24, the terminal 21 may receive the uplink service data transmitted by the subscriber 1 and the uplink service data transmitted by the subscriber 2 at the same time. If the service data is voice data, the terminal 21 may perform audio mixing to the uplink service data transmitted by the subscriber 1 and the uplink service data transmitted by the subscriber 2, and output the mixed data.

If the uplink service data transmitted by each subscriber is voice data, a process of mixing the downlink service data corresponding to other remote subscriber among the at least two remote subscribers which excludes the remote subscriber into uplink service data transmitted by the current subscriber may be an audio mixing process.

In this way, each remote subscriber can receive the uplink service data from other remote subscriber and the current subscriber, and the current subscriber also can receive the downlink service data corresponding to each remote subscriber. If the uplink service data is voice data, each remote subscriber can hear voices from other remote subscriber and the current subscriber, and the current subscriber also can hear voices from each remote subscriber.

Those skilled in the art can understand that, in some embodiments, the downlink data corresponding to each remote subscriber may be video call data or other types of service data.

For video call data, a corresponding mixing way may be employed according to requirements. For example, video call data transmitted by the first remote subscriber may be spliced with video call data transmitted by the second remote subscriber, or video call data transmitted by the first remote subscriber may be combined with video call data transmitted by the second remote subscriber according to time sequence.

For other types of service data, a corresponding mixing way may also be employed according to requirements. For example, the service data may be combined according to a predetermined order, which is not described in detail here.

In some embodiments, to improve data safety and save transmission resources, service data transmitted between terminals may be encoded. Therefore, the service data received by the multi-channel terminal is also encoded data. In some embodiments, before mixing the received downlink data corresponding to each remote subscriber, the multi-channel terminal may perform decoding to the received downlink data. Besides, before being transmitted to a target terminal, service data which has been subjected to mixing may be encoded.

In some embodiments, the terminal 21 may implement forwarding of downlink service data corresponding to at least one remote subscriber via a medium device 27.

Those skilled in the art can understand that, although only two remote subscribers are shown in FIG. 2, there may be more remote subscribers in practice. The service channel set up between the local terminal and the remote subscriber may be based on any one of WiFi, 2G, 3G, 4G and 5G networks, and may be the same as or different from the first network 28 or the second network 29.

In some embodiments, the current subscriber may remove a subscriber from the multi-party call by operating the terminal 21, or add a new remote subscriber to the multi-party call during the call. The above processes may be implemented via the terminal 21, and doesn't need to request a network to set up or terminate the multi-party call. Therefore, the multi-party call method provided in embodiments of the present disclosure may be more flexible, and lead to better user experience.

In embodiments of the present disclosure, before the multi-party call, the current subscriber may set up at least two service channels to further set up calls with at least two remote subscribers through the service channels, respectively. Each of the remote subscribers may set up a connection with the terminal where the current subscriber is located through an independent service channel. The service channels connecting the current subscriber and the at least two remote subscribers retain an activated state at the same time, so that data transmission is implemented among the current subscriber and the at least two remote subscribers.

Referring to FIG. 3, in an embodiment of the present disclosure, a multi-party call device for a multi-channel terminal is provided, including: an uplink service data receiving circuitry 32 configured to receive downlink service data corresponding to at least two remote subscribers through at least two service channels, respectively; and a service data mixing circuitry 33 configured to: for each of the at least two remote subscribers, mixing downlink service data corresponding to other remote subscriber among the at least two remote subscribers which excludes the remote subscriber into uplink service data transmitted by a current subscriber, and transmit to the remote subscriber the mixed uplink service data of the current subscriber through a service channel corresponding to the remote subscriber, wherein the at least two service channels are set up based on different wireless networks.

In some embodiments, the device may further include a call setting up circuitry 31 configured to: set up calls between the current subscriber and the at least two remote subscribers through the at least two service channels, respectively, wherein the at least two service channels are set up based on different wireless networks.

In some embodiments, for any remote subscriber, the uplink service data transmitted by the current subscriber may include service data generated by the current subscriber.

In some embodiments, the different wireless networks may be selected from WiFi network, 2G network, 3G network, 4G network and 5G network.

In some embodiments, the service channel may be a channel for transmitting service data, such as voice or video, and be used for handling voice service, video service and so on. In some embodiments, the call may include voice call, video call and so on. More embodiments may be obtained by those skilled in the art according to practical requirements, and are not described in detail here. Further, call means transmitting service data in a service channel.

In some embodiments, the device may further include a remote subscriber data mixing circuitry (not shown in FIG. 3) configured to: after downlink service data corresponding to the at least two remote subscribers are mixed, output the mixed data.

In some embodiments, in a call among the current subscriber and the at least two remote subscribers, the current subscriber may be a calling party or a called party.

In some embodiments, the device may be integrated in a mobile terminal, such as in a CPU of the mobile terminal, to implement solutions provided in the embodiments of the present disclosure.

Terms, working principles and advantages involved in the embodiments of the present disclosure may be referred to the above description of the multi-party call method for the multi-channel terminal, and are not described in detail here.

Those skilled in the art can understand that all of or a portion of the processes in the method provided in the above embodiments can be implemented by related hardware with instruction of computer program. The computer program may be stored in a readable storage medium, such as a magnetic disk, an optical disk, a Read-Only Memory (ROM) or a Random Access Memory (RAM).

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

What is claimed is:

1. A multi-party call method for a multi-channel terminal, comprising:
receiving downlink service data corresponding to at least two remote subscribers through at least two service channels, respectively; and
for each of the at least two remote subscribers, a local terminal mixing downlink service data corresponding to other remote subscriber among the at least two remote subscribers which excludes the remote subscriber into uplink service data transmitted by a current subscriber, and transmitting to the remote subscriber the mixed uplink service data of the current subscriber through a service channel corresponding to the remote subscriber,
wherein the at least two service channels are set up based on different wireless networks.

2. The method according to claim 1, wherein the uplink service data transmitted by the current subscriber comprises service data generated by the current subscriber.

3. The method according to claim 1, further comprising: after downlink service data corresponding to the at least two remote subscribers are mixed, outputting the mixed data.

4. The method according to claim 1, wherein in a call among the current subscriber and the at least two remote subscribers, the current subscriber is a calling party or a called party.

5. The method according to claim 1, wherein the different wireless networks are selected from WiFi network, 2G network, 3G network, 4G network and 5G network.

6. The method according to claim 1, wherein service corresponding to the at least two service channels comprises voice service or video service.

7. The method according to claim 1, wherein service corresponding to the at least two service channels comprises VoLTE service, Circuit Switched (CS) domain service or VoWiFi service.

8. The method according to claim 1, wherein the at least two service channels retain an activated state.

9. A multi-party call device for a multi-channel terminal, comprising:
an uplink service data receiving circuitry configured to receive downlink service data corresponding to at least two remote subscribers through at least two service channels, respectively; and
a service data mixing circuitry configured to: for each of the at least two remote subscribers, mixing downlink service data corresponding to other remote subscriber among the at least two remote subscribers which excludes the remote subscriber into uplink service data transmitted by a current subscriber, and transmit to the remote subscriber the mixed uplink service data of the current subscriber through a service channel corresponding to the remote subscriber,
wherein the at least two service channels are set up based on different wireless networks.

10. The device according to claim 9, wherein the uplink service data transmitted by the current subscriber comprises service data generated by the current subscriber.

11. The device according to claim 9, further comprising a remote subscriber data mixing circuitry configured to: after downlink service data corresponding to the at least two remote subscribers are mixed, output the mixed data.

12. The device according to claim 9, wherein in a call among the current subscriber and the at least two remote subscribers, the current subscriber is a calling party or a called party.

13. The device according to claim 9, wherein the different wireless networks are selected from WiFi network, 2G network, 3G network, 4G network and 5G network.

14. The device according to claim 9, wherein service corresponding to the at least two service channels comprises voice service or video service.

15. The device according to claim 9, wherein service corresponding to the at least two service channels comprises VoLTE service, Circuit Switched (CS) domain service or VoWiFi service.

16. The device according to claim 9, wherein the at least two service channels retain an activated state.
